(19) United States
(12) Patent Application Publication
(10) Pub. No.: US 2013/0067305 A1
(43) Pub. Date: Mar. 14, 2013

(54) COMPLEX FUNCTION GENERATOR

(71) Applicant: Michael GOLAN, Tel Aviv (IL)

(72) Inventor: Michael GOLAN, Tel Aviv (IL)

(73) Assignee: A-ONLINE CAPITAL (A.O.C.) LTD., Tel Aviv (IL)

(21) Appl. No.: 13/553,829

(22) Filed: Jul. 20, 2012

(30) Foreign Application Priority Data
Jul. 20, 2011 (IL) 214222
Aug. 13, 2011 (IL) 215125

(51) Int. Cl. G06F 17/21

(52) U.S. Cl. CPC G06F 17/215
USPC 715/219

(57) ABSTRACT

A method of creating a user defined function (UDF) in a data processing application program comprising inserting a formula into the application program; assigning a UDF identifier to said formula; and storing said UDF identifier in a complex function generator configured to call said formula responsive to a reference to said UDF identifier in the application program.

### CROSS-REFERENCE TO RELATED APPLICATIONS

This application claims priority from Israel Patent Application No. 214222 filed 20 Jul. 2011, and of Israel Patent Application No. 215125 filed 13 Aug. 2011, both of which are hereby incorporated in their entirety by reference.

### FIELD OF THE INVENTION

The present invention relates to data processing generally and to a system and method for manipulating data.

### BACKGROUND OF THE INVENTION

Electronic spreadsheets are generally used with data processing devices for facilitating storing and processing of information in databases and/or for data analysis, including numerical analysis. Data is generally tabulated and manipulated by a user through a graphical unit interface (GUI) which may be included in the data processing device. The user typically arranges the data into an array, or table, having cells distributed horizontally in rows and vertically in columns. The cells are generally identified by their location in the array using row and column identifiers. The identifiers may be, for example, a row number and a column number, so that a cell identified as (6, 11) may be associated with being positioned at the intersection of row 6 with column 11, in the spreadsheet. In some cases, the identifiers may be numbers for rows and letters for columns so that a cell designated (D23) is located in column D, row 23, in the array. Other possible identifiers may be used, for example, letters for rows and numbers for columns, or letters for both rows and columns

Spreadsheets may include functions which allow a user to manipulate the contents of one or more cells. Frequently, the contents of the one or more cells are manipulated for generating new data which may be placed in an occupied cell or an unoccupied cell (an empty cell containing no data). The functions may be library functions which are preset in the spreadsheet and may be applied by entering predefined symbols associated with a particular library function. Some types of library functions may include mathematical functions, logical functions, and statistical functions, among others. Spreadsheets may also include non-library functions which may be created by the user, and in some cases, may include the use of library functions.

More information on spreadsheets may be found in the Internet, for example, in www.ehow.com.

### SUMMARY OF THE PRESENT INVENTION

There is provided, in accordance with an embodiment of the present invention, a method of creating a user defined function (UDF) in a data processing application program comprising inserting a formula into the application program; assigning a UDF identifier to the formula; and storing the UDF identifier in a complex function generator configured to call the formula responsive to a reference to the UDF identifier in the application program.

In accordance with an embodiment of the present invention, the method further comprises inserting one or more input parameters associated with arguments of the UDF into the application program and storing the arguments in the complex function generator.

In accordance with an embodiment of the present invention the application program is a spreadsheet.

In accordance with an embodiment of the present invention, the method further comprises permanently embedding the formula in the application program

In accordance with an embodiment of the present invention, the method further comprises temporarily embedding the formula in the application program.

In accordance with an embodiment of the present invention, calling the function includes executing a routine in the complex function generator.

In accordance with an embodiment of the present invention, the routine is preprogrammed in the complex function generator.

There is provided, in accordance with an embodiment of the present invention, a method of manipulating data using an application program including a UDF created using a method comprising inserting a formula into the application program; assigning a UDF identifier to the formula; and storing the UDF identifier in a complex function generator configured to call the formula responsive to a reference to the UDF identifier in the application program; the method further comprising inserting one or more input parameters into the application program; and referencing the stored UDF identifier in the application program.

In accordance with an embodiment of the present invention, the method further comprises calling the UDF responsive to the referencing.

In accordance with an embodiment of the present invention, the method further comprises generating a UDF output in the spreadsheet responsive to the calling.

In accordance with an embodiment of the present invention, the method further comprises generating the UDF output in a location stored in the complex function generator.

In accordance with an embodiment of the present invention, the input parameter is manually input by a user.

In accordance with an embodiment of the present invention, the input parameter is imported from an external program or from a different spreadsheet.

In accordance with an embodiment of the present invention, the importing is automatically performed.

In accordance with an embodiment of the present invention, the method further comprises exporting the UDF output to an external program or to a different spreadsheet.

In accordance with an embodiment of the present invention, the exporting is automatically performed.

In accordance with an embodiment of the present invention, the output is a trigger signal for an alarm.

There is provided, in accordance with an embodiment of the present invention, a data processing device for manipulating data using a customized data processing application program comprising a processor; a memory; a complex function generator configured to call on a UDF created in the customized application program and having a stored UDF identifier associated with the UDF.

In accordance with an embodiment of the present invention, the device further comprises a communication module for receiving the data from a database.

In accordance with an embodiment of the present invention, the device further comprises a graphical unit interface.

In accordance with an embodiment of the present invention, the device further comprises data entry and display means.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an exemplary system for manipulating data in data processing devices, according to an embodiment of the present invention;

FIG. 2 schematically illustrates an exemplary data processing device including a complex function generator for manipulating data, according to an embodiment of the present invention;

FIG. 3 is a flow chart of a method of using a data processing device having a complex function generator for creating a customized application program and manipulating data, according to an embodiment of the present invention;

FIG. 4 is a flow chart of an exemplary method of operating a complex function generator for creating a customized function in an application program and for manipulating data, according to an embodiment of the present invention;

FIG. 5-FIG. 7 illustrate exemplary screen shots of a processing device display implementing the method of using a complex function generator for manipulating data in a financial transaction software package, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that data processing devices may be configured to allow users, including users without prior programming experience, to create and embed customized functions in program applications used for data processing. An example of such program applications may be electronic spreadsheets, whose functionality may be potentially increased by the ability given by the present disclosure to “non-programmers” to create and embed functions which may be easily tailored to data manipulation requirements. The applicants have further realized that these “customized” application programs, including the “customized” spreadsheets, may be additionally used to manipulate data in external software programs, some of which may include data arrays. For convenience hereinafter, the term “customized function” may be used interchangeably with the term “user-defined function” or “UDF”.

The Applicants have devised a complex function generator which may be included in data processing devices for customizing data processing application programs, and for data manipulation. The generator may be configured to store one or more identifiers associated with user-defined-functions (UDFs) created and embedded by a user in the application program. The generator may be further configured to call the UDFs for execution responsive to an application program reference to the one or more UDF identifiers. The UDFs may be permanently embedded in the application program for use during multiple program sessions, for example as library functions, or alternatively, may be temporarily embedded in the application program for use during a single program session. Implementation of the complex function generator may be in hardware, software, or a combination of both.

In accordance with an embodiment of the present invention, the complex function generator may allow manipulation of real-time data accessed through a communication network. It may also allow manipulation of data downloaded through the communication network and stored in a data processing device. An exemplary manipulation may include the steps of (1) importing the real-time data or the downloaded data into an application program, for example into a spreadsheet from an external software package used to acquire the data, (2) creating one or more UDFs in the application program, (3) operating on the imported data, and (4) exporting the resultant or output data back into the external software package for further use or processing. An alternative manipulation may include generating one or more UDFs in the application program, and calling on these functions to operate on the real-time data or the downloaded data in the external software package. This alternative manipulation may eliminate the steps of importing and operating on the data into the application program, and exporting the resultant data from the application program into the software package. In some applications, the manipulation may be responsive to variations in the acquired data, and may be automatically performed upon detection of the variations. In some applications, the customized application program may be used for manipulating data not accessed through the communication network, for example, data input by the user into the application program for calculation purposes and other mathematical analyses.

In accordance with an embodiment of the present invention, external software package may include application-specific software. Examples of such application-specific software may include financial data acquisition software, scientific measurements acquisition software, or any other type of software suitable for data acquisition and/or processing. A more specific example of such an external software package is ACE, a real-time financial data and trading software package.

In the art, customized functions may generally be created only by users having programming experience and an understanding of the application program's source code. They may also require usage of the application program Integrated Development Environment (IDE). Frequently, these functions may include a mixture of some or all of local data, imported data, constants and variables, standard functions, library functions or ‘macro’ functions, and may include using brackets, arithmetic symbols and other functions. The more complicated the customized function becomes; the more difficult it may be to formulate it, debug and find errors in it. The Applicants, in embodiments of the present invention, provide solutions to the complexity of creating customized functions in data processing application programs, which allow even users without programming experience to create customized functions.

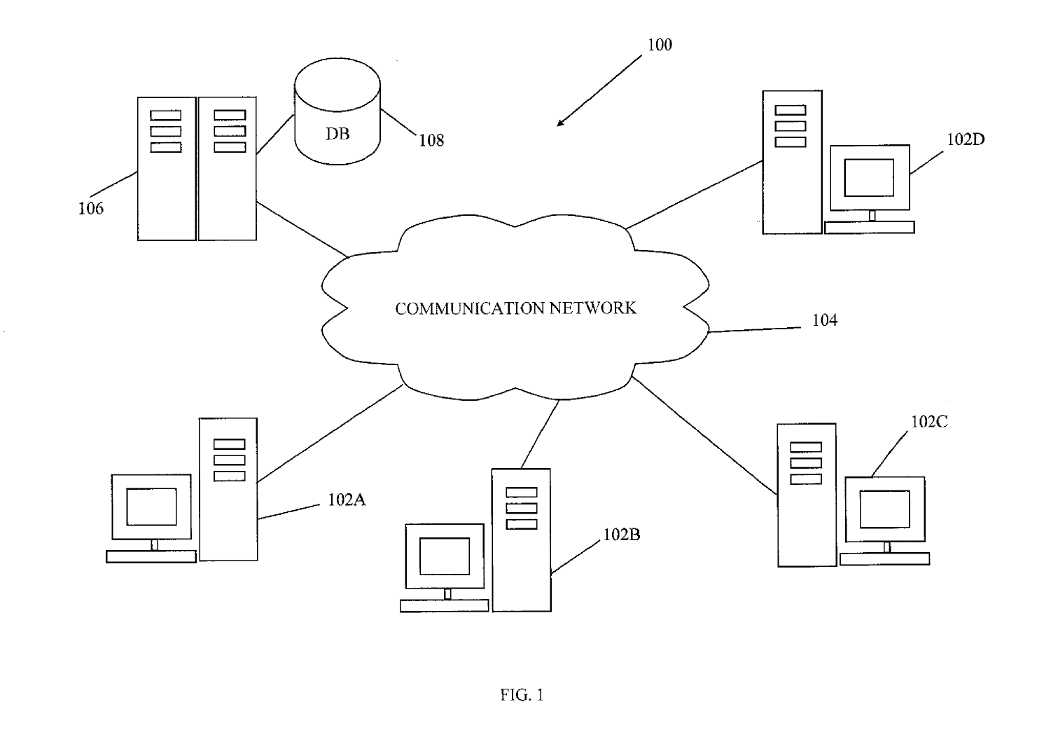

Reference is now made to FIG. 1 which schematically illustrates an exemplary system 100 for manipulating data using data processing devices, according to an embodiment of the present invention. System 100 includes a plurality of data processing devices 102A-102D connecting through a communication network 104 to a data server 106 including a data base 108.

In accordance with an embodiment of the present invention, data processing devices 102A-102D may be configured to access data from data base 108 and to allow users to create and embed UDFs in data processing application programs, including for example electronic spreadsheets. Data processing devices 102A-102D may be additionally configured to manipulate the accessed data from database 108 using these application programs. The application programs may be stored in processing devices 102A-102D and may be recurringly used for data manipulation. The application programs with the UDFs may additionally or alternatively be store in server 106 and/or database 108. Additionally or alternatively, the application programs with the UDFs may be stored in one or more of the data processing devices, and be accessed by the other processing devices. For example, the data processing application program including the UDFs may be stored in data processing device 102A or 102B and also be available for access by the other data processing devices (e.g. 102C, 102D). This may be useful, for example, in applications which may require repeating the same data manipulation on recurring data acquisitions from database 108. The recurring data acquisitions may include continuous, periodic, or sporadic access to the data in database 108. The application programs may also be used in a single program session associated with a single session of data acquisition (non-recurring data acquisition). Single-use application programs may not necessarily require storing in processing devices 102A-102D, and may be temporarily generated for the one-time application. The UDFs for the application programs may be generated by a known spreadsheet software program, for example Excel or similar program, which may be stored in processing devices 102A-102D. An external software package may be stored in processing devices 102A-102D and may be used for acquiring the data from database 108. The external software package may include application-specific software. The external software packages and the application programs may be downloaded from the Internet to processing devices 102A-102D through communication network 104, or from server 106 or database 108 through the communication network. Alternatively, the external software packages and the application programs may be downloaded to processing devices 102A-102D from a computer readable storage medium.

In accordance with an embodiment of the present invention, manipulating the acquired data, including creating the UDFs in the application programs, may include use of data entry and visual display means in processing devices 102A-102D. The manipulation may be done real-time by allowing the user to view the acquired data and the data processing real-time. Additionally or alternatively, the acquired data may be stored in processing devices 102A-102D for later manipulation and display. Some examples of the data which may be viewed by the users may include the acquired data, acquired data imported into the application programs, the UDFs in the application programs, resultant data in the application programs, resultant data imported into the external software package, among other information of possible interest. The information may be viewed in one or more windows on a single screen on the display means, or alternatively, on multiple screens (may include multiple physical screens or by way of switching from one screen to another).

In accordance with an embodiment of the present invention, activating an application program and manipulating the acquired data may be manually performed by the users on processing devices 102A-102D. Additionally or alternatively, the activation may be automatically performed by processing devices 102A-102D. A combination of manual and automatic activation may also be possible. Manual activation may include the user manually inputting data at defined locations in the application program and calling the UDF by manually specifying the stored UDF's identifier in an output location. Calling the UDF may result in its execution using the input data as UDF parameters. The resultant data from the UDF's execution may be placed in the output location, or in any other location which may be defined by the user when calling the function. Automatic activation of the application program may be responsive to an external signal, for example, a warning signal received from the external software package. The warning signal may be issued when the resultant data may be of interest, for example, when there are variations in the acquired data (e.g. negative variations, positive variations, variation above or below certain limits), or new data is received. Data input to the cells may be automatically imported from the external software package and the resultant data automatically generated through an automatic call to the function identifier. The resultant data may be automatically exported to the external software package for display and/or further processing. Alternatively, the application program may be automatically activated by the warning signal and the called function may include commands for processing the data in the external software package, eliminating import and export of data between the application program and the external software package.

In accordance with an embodiment of the present invention, communication network 104 may be a wireless network, a wired network, or a combination of both, and may include for example, a wide area network (WAN), a local area network (LAN), a wireless regional area network (WRAN), WiMAX (Broadband Wireless Access), or Wi-Fi, among others. Communication network 104 may include the Internet. Communication network 104 may connect data processing devices 102A-102D with database 108 through server 106. Server 106 may be a host server, a gateway server, or may include both.

In accordance with an embodiment of the present invention, database 108 may include a real-time database adapted to handle data on a real-time basis. The data may include financial data which may be associated with stock markets, commodities exchange markets, currency markets, or any other type of financial markets with which real-time transactions and operations are generally associated. The data may additionally or alternatively include any type of data in any field of interest which may involve real-time monitoring of information. Database 108 may additionally or alternatively include stored historical data associated with any of the aforementioned data, or with any type of data which may be of interest to a user for manipulation with processing devices 102A-102D, including for example, mathematical data, statistical data, experimental data, measurement data, among others.

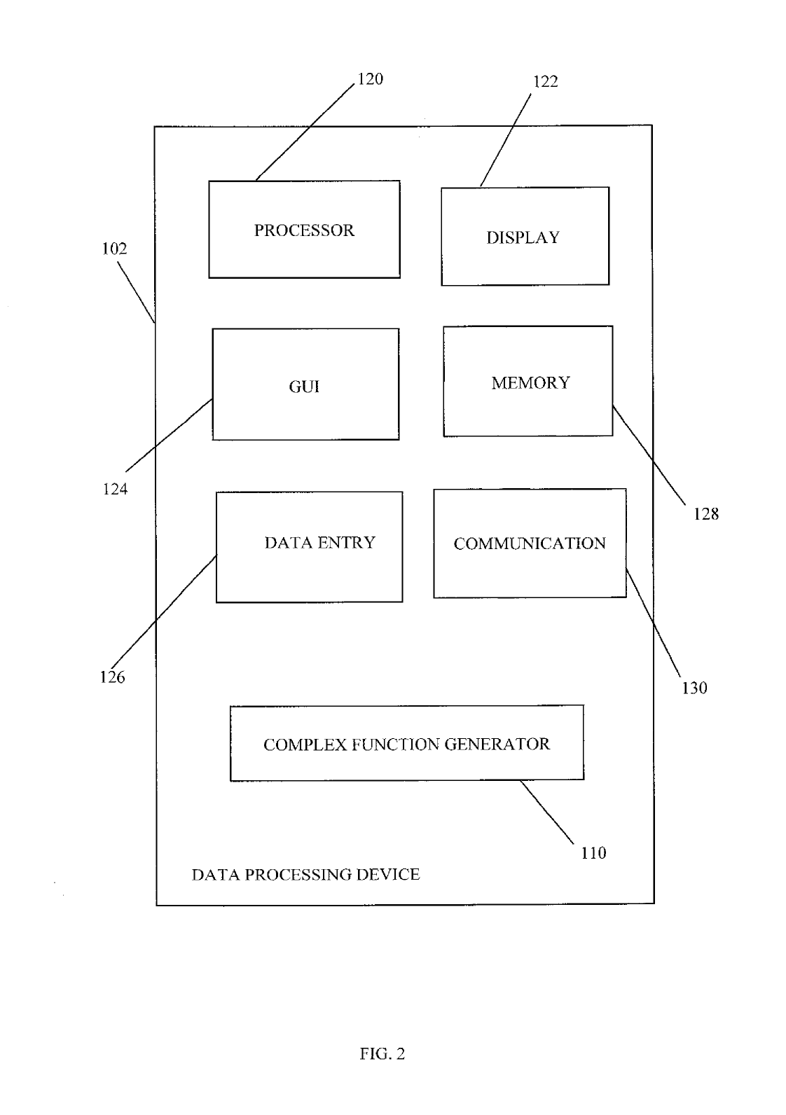

Reference is now made to FIG. 2 which schematically illustrates an exemplary data processing device 102 including a complex function generator 110 for manipulating data, according to an embodiment of the present invention. Data processing device 102 may additionally include a processor 120, a display 122, a graphical unit interface (GUI) 124, an input/output (I/0) module 126, a memory 128, and a communication module 130. Data processing device 102 may be similar to data processing devices 102A-102D shown in FIG. 1, and may include a personal computer, a portable computer (laptop), a work station, a tablet computer, or any other data processing device suitable for creating customized application programs and for manipulating data using the customized application programs.

In accordance with an embodiment of the present invention, complex function generator 110 may be used to customize application programs by allowing users to create and embed UDFs in the application programs. Complex function generator 110 may additionally allow the users to execute the embedded UDFs for manipulating data input into the application program and/or data accessed through external software programs.

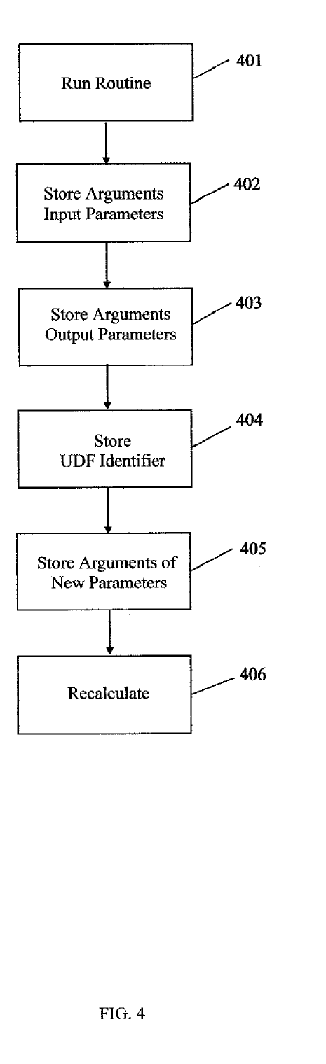

In accordance with an embodiment of the present invention, complex function generator 110 may store a UDF identifier associated with the UDF created by the user and embedded in the application program, and may store arguments associated with the UDF's input and output parameters. Complex function generator 110 may call on the UDF for execution responsive to a reference in the application program to the stored UDF identifier, and additionally may point the function to the location of the input and output parameters based on the stored UDF arguments. A more detailed description of the operation of an embodiment of complex function generator 110 is provided further on below with reference to FIG. 4.

In accordance with an embodiment of the present invention, complex function generator 110 may be included in processing device 102 as an add-in module including a computer readable storage medium. Additionally or alternatively, complex function generator 110 may include a software package downloadable to processing device 102 through a communication network, for example communication network 104 shown in FIG. 1.

In accordance with an embodiment of the present invention, processor 120 may be a Central Processing Unit (CPU), a microprocessor, an electronic circuit, an Integrated Circuit (IC) or the like. Processor 120 may be utilized to perform computations required by data processing device 102 or any of it subcomponents. Processor 120 may be configured to execute computer-programs associated with operation of complex function generator 110.

In accordance with an embodiment of the present invention, GUI 124 may be configured to interface between the user and complex function generator 110 by generating display data on display 122. The display data may include graphics and other images, including input fields, spreadsheets, tables, data arrays, icons, figures, and the like, which may be used for customizing the application program and for manipulating data. GUI 124 may be further configured to generate additional display data on display 122 associated with operation of data processing device 102. GUI 124 may additionally process user inputs for display on display 122.

In accordance with an embodiment of the present invention, data entry module 126 may be utilized to receive data input from the user, and may include data entry means such as for example, a keyboard, a mouse, and the like. Data entry module 126 may be interfaced with GUI 124 and display 122 for inputting data, and for pointing and selecting spreadsheet cells, array data, input fields, figures, images which may be displayed on display 122.

In accordance with an embodiment of the present invention, memory 128 may be a short-term storage device or long-term storage device. Memory 128 may be a persistent storage or volatile storage. Memory 128 may include a disk drive, a Flash disk, a Random Access Memory (RAM), a memory chip, or the like. Memory 128 may be configured to retain program code operative to cause processor 120 to perform acts associated with any of the subcomponents of data processing device 102. Memory 128 may additionally store data processing algorithms, the external software packages, and the program code associated with complex function generator 110. Memory 128 may additionally store the UDF identifiers and the UDF arguments input from the application program.

In accordance with an embodiment of the present invention, communication module 130 is configured for connecting data processing device 102 with a communication network, for example, communication network 104 in FIG. 1. Communication module 130 may include receiving functions for accessing data from a data base, for example, database 108 in FIG. 1, and may also include receiving functions for receiving other types of information through communication network 104. Communication module 130 may further include transmitting functions for transmitting information through communication network 104, for example, connection information.

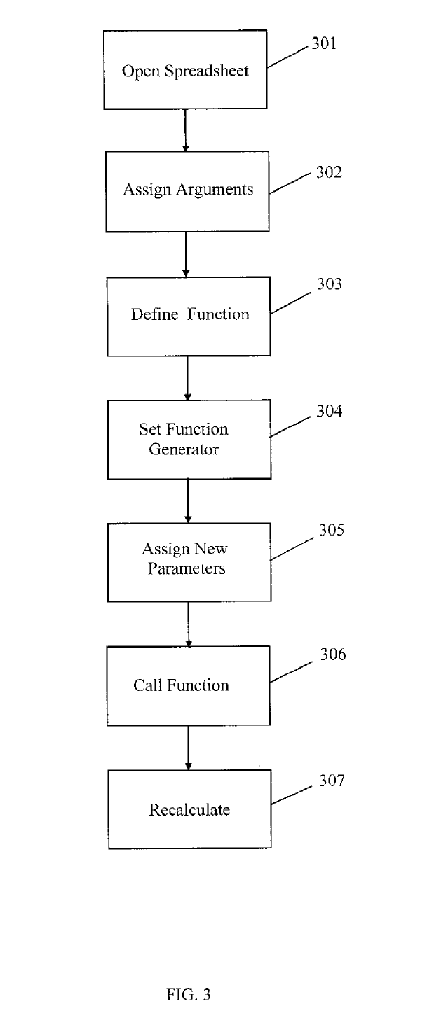

FIG. 3 is a flow chart of an exemplary method of using a data processing device having a complex function generator for creating a customized application program and for manipulating data, according to an embodiment of the present invention. For convenience in describing the method and in a non-limiting manner, reference may be made to data processing device 102 including complex function generator 110 shown in FIG. 2. Similarly for convenience in describing the method and in a non-limiting manner, reference may be made to use of Excel spreadsheet program for customizing the spread sheet and for data manipulation. Steps 301-304 describe the customizing of the application program, while steps 305-307 describe the data manipulation using the customized application program. Steps making reference to user manipulations, for example by inputting data, and the like, may possibly be replaced by automatic manipulations, or by semi-automatic manipulation partially combining user manipulations with automatic manipulation.

At 301, a user may open a spreadsheet from the Excel spreadsheet program which may be stored in memory 128.

At 302, the user may define in the spreadsheet the arguments which may be used in the user formula (which will be used later in the UDF as parameters). The arguments may be defined by referring to cells in the spreadsheet, for example, D1, D2, E1, and so on (the column and row identifiers are per Excel spreadsheet program). The arguments may include input parameters, which may be, for example, values. Alternatively to values, the input parameters may include other types of data, for example, reference to locations in tables and/or data arrays in external software programs, or to cell locations in the same spreadsheet or other spreadsheets. The input parameters may additionally include library functions included in the spreadsheet program, or previously and/or newly created UDFs. The location of the input parameters in the spreadsheet may be selected by the user according to preference, whether manually input by the user, or imported from an external software package, or transferred from another location on the same spreadsheet or from another spreadsheet.

As an example, assuming that the user is interested in calculating the average A of three values P1, P2, and P3, the user may then define the arguments by inputting the values in cells in the spreadsheet, as follows:

In cell D1 insert the value 18 (input parameter P1);

In cell D2 insert the value 22 (input parameter P2); and

In cell E6: insert the value 41 (input parameter).

At 303, the user may define a user formula and the location of the output or resultant data. The term “formula” may refer to a calculation or manipulation performed on one or more input parameters. The user formula may be permanently embedded in the spreadsheet when the spreadsheet is saved, for example, by storing the spreadsheet in memory 128. Alternatively, the user formula may be temporarily embedded for use while the spreadsheet is open if not saved. The user formula may be manually input by the user or may be imported from a different cell location in the spreadsheet, or from another spreadsheet, or from the external software package.

Continuing from the previous example, the average A of the arguments D1, D2, and E6 is calculated:

In F22, insert the user formula=(D1+D2+E6)/3

Where the output value is the result from the execution of the user formula is calculated in cell F22, in this case the value 27.

At 304, the user may set complex function generator 110 by referencing in a cell in the spreadsheet a source code routine stored in the generator, and by assigning a UDF identifier to the user formula. The source code routine may be used to create the UDF and associate the UDF identifier, which may be stored in complex function generator 110, with the embedded UDF in the spreadsheet. Syntax to add user defined functionality to existing application programs, including spreadsheet programs, are known in the art and are available for most, if not all, application programs. For adding functionality using UDF identifiers to Excel spreadsheet, the routine may include a function which references cells in the spreadsheet such as, for example, “addUDF( )” with the arguments included inside the parenthesis. The program routine may be preprogrammed into complex function generator 110 according to the type of spreadsheet program which will be used for the data manipulation. This may allow a user to set up complex function generator 110 by referencing user formula and identifying in the reference the UDF identifier, and without requiring any programming knowledge or knowledge of the spreadsheet program source code.

For example, continuing from the previous example, the UDF identifier is assigned to the user formula, and complex function generator 110 is set by calling the preprogrammed source code routine, as follows:

In G4, insert the call to the routine, newfunc (“Ave”, F22, D1, D2, E6)

where G4 is the cell where the routine by the name of “newfunc” is referenced (the name of the routine may be any name defined in the preprogrammed routine and the reference cell may be any cell selected by the user); “Ave” is the UDF identifier associated with the user formula and may be any name, word, letters, numbers, or any combination of them; F22 is the argument (cell location) for the resultant data from the execution of the user formula, and D1, D2, and E6, are the arguments (cell locations) for the input parameters.

At 305, the spreadsheet is customized and may be used for data manipulation following setting of complex function generator 110 in step 304. The user may input new parameters for the arguments in the following calls to the UDF. These parameters may be manually input by the user or may be imported from an external software package, or from another cell in the same spreadsheet or from a different spreadsheet. The parameters may be automatically identified by the UDF from prior setting of the parameters in the user formula. The parameters may be the same type of parameters used to create the UDF, or may be different types of parameters, for example, parameter types which reference data located in other cell locations within the same spreadsheet or different spreadsheets, or which may reference to data locations in a table or data array in the external software package, or which reference library functions or embedded functions. The number of input parameters required by the UDF may be the same as the number of input parameters used when defining the UDF. The UDF may be defined with no parameters (zero parameters UDF). Such zero parameter UDF may use external sources as parameters (for example, real-time feed via communication line), or may not use parameters at all and may return a constant value with each call to the UDF.

Continuing from the previous example, the user may now use the UDF with different set of parameters. For example, the user may define the arguments as follows in the spreadsheet:

In H3, insert the value 14 (input parameter P1);

In H7 insert the value 22 (input parameter P2); and

In J7 insert the value 12 (input parameter P3).

At 306, the UDF may be called by the user referencing the UDF identifier in a cell in the spreadsheet and including the arguments associated with the new input parameters.

Continuing from the previous example,

In J10, insert the call to the newly created function Ave (H3, H7, J7).

where Ave is the UDF identifier and H3, H7, and J7, are the new arguments required by the UDF for the average calculation.

At 307, the spreadsheet recalculates the UDF using the new parameters and outputs the resultant data A in the specified cell J10. The output A is the resultant data from the execution of the UDF with data from arguments H3, H7, and J7:

Continuing from the previous example:

In J10 the value output is 16.

The above exemplary method is intended to describe one possible way of using a data processing device including a complex function generator for customizing a spreadsheet and for manipulating data using the spreadsheet. An ordinary person skilled in the art may appreciate that the method may be practiced with variations, for example, by including more or less steps, or by changing the sequence of steps, or by introducing changes in the steps.

Reference is now made to FIG. 4 which is a flow chart of an exemplary method of operating a complex function generator for creating a customized application program and for data manipulation, according to an embodiment of the present invention. For convenience in describing the method and in a non-limiting manner, reference may be made to complex function generator 110 shown in FIG. 2, and to the use of the Excel spreadsheet as described for the method of FIG. 3. Steps 401-404 describe the operation of setting the complex function generator 110 for creating the function, while steps 405-406 describe the operation of the complex function generator, following setting for manipulating the data using the customized spreadsheet.

At 401, complex function generator 110 may run a preprogrammed source code routine responsive to a routine reference in a spreadsheet. For a description of the source code routine, see step 304 above.

At 402, complex function generator 110 may store the arguments associated with the UDF input parameters. For a description of the arguments associated with the input parameters, see step 302 above.

At 403, complex function generator 110 may store a location of the resultant data output by the execution of the customized function. For a description of the output data, see step 303 above.

At 404, complex function generator 110 may store the UDF identifier associated with the UDF (which is based on the user formula). For a description of the UDF identifier, see step 304 above. Complex function generator 110 is now set and may be used for data manipulation.

At 405, complex function generator 110 may store or use the arguments associated with new input parameters. The arguments may be stored in the same memory location as the arguments in step 402, possibly overwriting the previously stored arguments. Alternatively, the arguments may be stored in a different memory location and a relation between the locations of the two sets of arguments may be maintained. For a description of the arguments and the new input parameters, see step 305 above.

At 406, complex function generator 110 may call the embedded UDF responsive to the UDF identifier reference in a spreadsheet. The arguments associated with the new input parameters may be provided to the UDF for recalculating the function. For a description of the operation of calling the embedded UDF and recalculating the function, see steps 306 and 307 above.

The above exemplary method is intended to describe one possible way of using a complex function generator for customizing a spreadsheet and for manipulating data using a spreadsheet. An ordinary person skilled in the art may appreciate that the method may be practiced with variations, for example, by including more or less steps, or by changing the sequence of steps, or by introducing changes in the steps.

The disclosed system and method for easily customizing spreadsheets and using the spreadsheets for data manipulation may find particular use by traders in the finance markets. In this context, the term traders includes stock brokers, hedge fund managers, and money managers who monitor tradable commodity prices and may make decisions in real time as to whether to buy or sell. Such traders may require standard data fields for individual commodities such as, for example, current prices and highest and lowest prices over a time interval. They may also be interested in tracking the volume of transactions. This data is generally standard and available to all traders. Each trader may use various criteria to analyze the data and develop an understanding of the market. In some applications, the analysis may then be used for decision making. It may be possible that unique ways of combining standard data fields with or without additional variables may differentiate the performance of one trader from another. The criteria may be applied to all records by creating a function that reflects that criteria. This may merely relate to the data corresponding to the company, or may also include other variables such as biorhythms, the date, or other inputs.

Whatever criteria the trader may use, it may be useful if a function can be customized in a step by step manner in a temporary work area and only after verification, may be applied to all the records in a spreadsheet. Doing so may make it possible for the function to be applied correctly to each record and the performance of the various records compared using the same criterion, which, as explained above, may be trader specific.

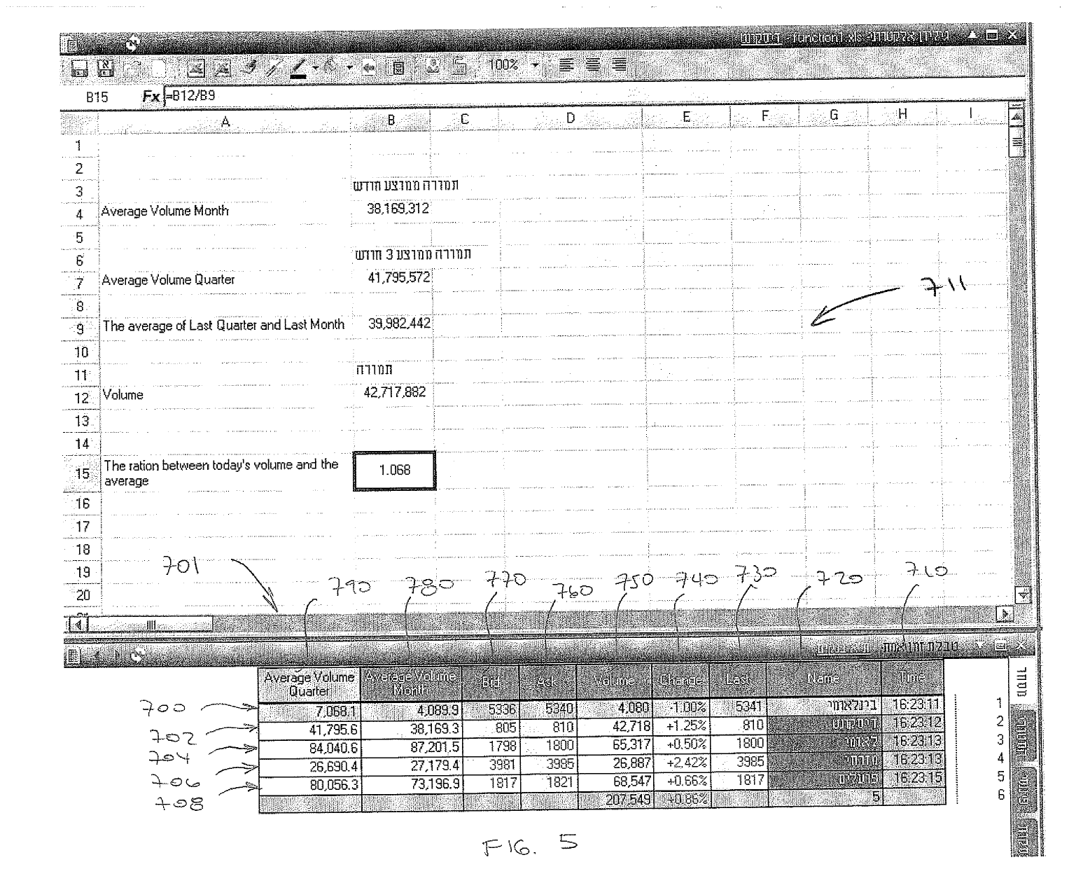

Reference is now made to FIG. 5-FIG. 7 which illustrates exemplary screen shots of a data processing device display implementing the method of using a complex function generator, according to an embodiment of the present invention. The data processing device and the complex function generator may be similar to data processing device 102 and complex function generator 110 shown in FIG. 2. For exemplary purposes, the screen shots are of the Applicants proprietary financial transaction software, ACE, and serve to show implementation of the method.

On the lower window in FIG. 5, standard trading data for 5 Israeli bank shares is shown. The bank shares are tabulated in consecutive lines of an array 701 and are Ben-Leumi 700, Discount 702, L'eumi 704, Mizrachi 706 and HaPoalim 708 respectively.

From right to left (in Hebrew style), the first column 710, headed time, is an indication of when the record was last updated. The second column 720 gives the names of the banks. The third column 730 displays the last share price. The fourth column 740 shows the change on the day, and the fifth column 750 shows the volume of shares traded that day. The sixth 760 and seventh 770 columns provide ask and bid data, the eighth column 780 shows the average volume of shares traded per month and the ninth column 790 shows the average volume of shares traded per quarter. It may be appreciated that the data described so far, is typical and exemplary of the type of data which may be displayed by many share trading packages and in the present context may be considered raw data inputs.

Each trader, based on his/her intuitive understanding of market forces or customer requirements may wish to track customized functions linking some of the above data fields.

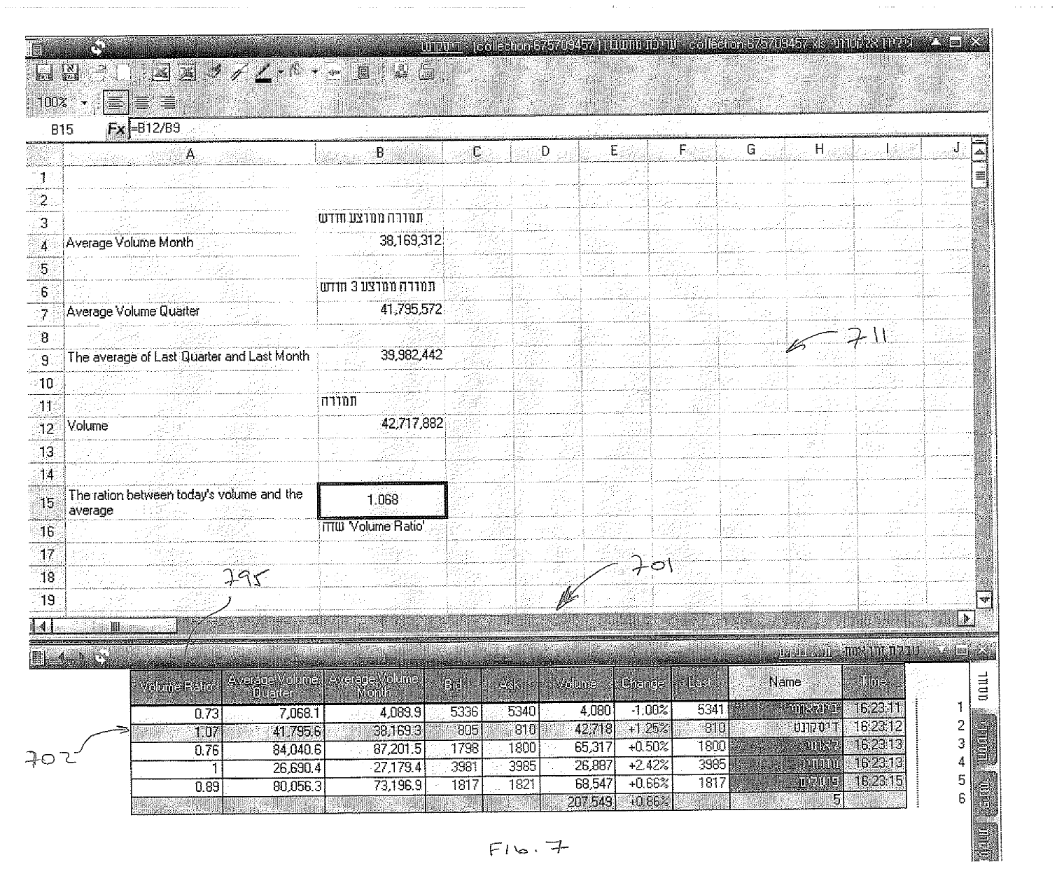

With reference to FIGS. 5-7, by way of a non-limiting example, it may be assumed that a trader may be interested in viewing, for example, ratios of average value per quarter and for the last month. The trader may additionally be interested in creating a new parameter that is more sensitive to last month data than to data from the whole of the previous quarter, but is, nevertheless, influenced by the previous couple of months. In the upper window of FIG. 5, which is a spreadsheet, for example an Excel spreadsheet 711 (also in FIG. 7), lines 4 and 7, the column headings of the 8^{th} and 9^{th} columns 780, 790 are exported into cells A4 and A7, and the associated real-time values for the second data record, i.e. Bank Discount 702 are exported into cells B4 and B7.

A user formula, manipulating the values of B4 and B7, may be inserted into a different cell, in this case, B9, and an appropriate description may be inserted into the adjacent cell A9. In the specific case, the user formula is an average of the values of B4 and B7, and reflects a weighted average of the previous three months, more susceptible to variation in the previous month. It may be appreciated, however, that other combinations are possible.

Further shown in FIG. 5, as part of the example, the current share trading volume is exported into B12 and the user formula calculating the ratio of today's current, real-time volume to the weighted average inserted into B9 (which by itself is calculated by the user formula), is inserted into B15. Not shown in the screen shot is a call made to a routine called “addField( )” which is ACE's implementation of the aforementioned addFunc( ) routine. In Ace's implementation, addField( ) uses as arguments the UDF identifier, Volume Ratio and a reference to the output cell, B15, in the given example. The addField routine does not take the additional arguments of B4 and B7 as this specific implementation includes a method to find this parameter fields automatically. In addition, the call to the addField( ) routine exports the name of the UDF Identifier to Ace.

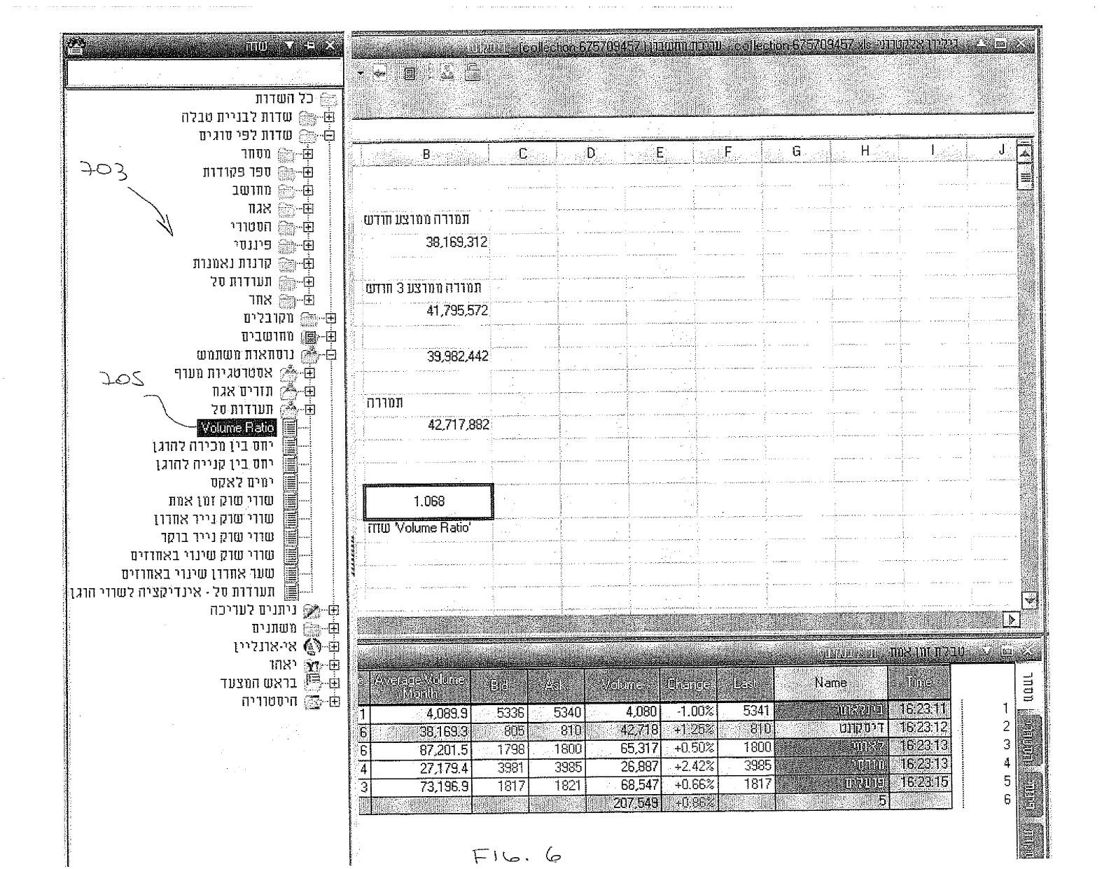

FIG. 6 shows a portion of the screen shot of FIG. 5 with a tree menu 703 (which is created by the program ACE) for selecting data fields. The UDF identifier Volume Ratio 705 is shown in tree 703. The user (the trader) may choose the previously saved customized ‘Volume Ratio’ function 705 from tree menu 703 and retrieve it back to the end column 795 of Bank shares array 701 in the lower window of FIG. 7.

FIG. 7 shows Bank shares array 701 with additional column 795 of data as it appears, i.e. the text ‘Volume Ratio’ as a header of the column and the calculated values at each row in the column.

In the worksheet, on upper window of FIG. 7, cells B4, B7 and B12 are exported data fields and cells B9 and B15 are customized user formula; all corresponding currently to data associated with Bank Discount 702 (on line 2 of the data array). The use of live, real-time data in the worksheet which the user uses to create the function allows the user to validate the function before importing it back to bank shares array 701.

Bank shares array 701 and spreadsheet 711 may be linked so that updating one automatically may update the other. Alternatively, updating may be on demand. Pointing with a mouse over a customized function in spreadsheet 711 may highlight the cells used in creating the function, and the corresponding data fields in array 701. Inserting the customized function into array 701 may create a local-referenced function linking to fields in the record, and may allow faster updating.

Previously, hereinabove, a stock exchange investment application has been described. By way of example only, in continuation of such an example, embodiments of the present invention may be directed to creating an algorithm for comparing a derived function relating to stocks or shares to one or more threshold values such that if the stock price falls below one threshold value, a stock or share should be sold, and if it exceeds a different threshold value a quantity of the stock or share should be bought. An application may be implemented for alerting the investor as to the variations, for example by providing an indication to buy or sell. In some cases, the applications may interface with a broker and automatically perform the transaction.

It may be appreciated that the application for alerting a user described hereinabove may be implemented in various scenarios and applied to other applications, and not limited to finance. For example, in horticulture, relevant parameters such as temperature and humidity data, time since planting, the time of day and wholesale prices for a crop could be linked in an algorithm and used to trigger an artificial irrigation system such as sprinklers or the like. Similarly it may be appreciated that electricity costs vary around the clock. Artificial light may promote plant growth and an appropriate algorithm could be used to trigger illumination of a crop.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of creating a user defined function (UDF) in a data processing application program comprising:
inserting a formula into the application program;
assigning a UDF identifier to said formula; and
storing said UDF identifier in a complex function generator configured to call said formula responsive to a reference to said UDF identifier in the application program.

2. A method according to claim 1 further comprising inserting one or more input parameters associated with arguments of the UDF into the application program and storing said arguments in said complex function generator.

3. A method according to claim 1 wherein the application program is a spreadsheet.

4. A method according to claim 1 further comprising permanently embedding said formula in the application program

5. A method according to claim 1 further comprising temporarily embedding said formula in the application program.

6. A method according to claim 1 wherein calling said function includes executing a routine in said complex function generator.

7. A method according to claim 6 wherein said routine is preprogrammed in said complex function generator.

8. A method of manipulating data using an application program including a UDF created using the method of claim 1, the method comprising:
inserting one or more input parameters into the application program; and
referencing said stored UDF identifier in the application program.

9. A method according to claim 8 further comprising calling the UDF responsive to said referencing.

10. A method according to claim 9 further comprising generating a UDF output in the application program responsive to said calling.

11. A method according to claim 11 further comprising generating said UDF output in a location stored in said complex function generator.

12. A method according to claim 8 wherein said input parameter is manually input by a user.

13. A method according to claim 8 wherein said input parameter is imported from an external program or from a different application program.

14. A method according to claim 8 wherein said importing is automatically performed.

15. A method according to claim 10 further comprising exporting said UDF output to an external program or to a different application program.

16. A method according to claim 10 wherein said exporting is automatically performed.

17. A method according to claim 10 wherein said output is a trigger signal for an alarm.

18. A data processing device for manipulating data using a customized application program comprising:
a processor;
a memory;
a complex function generator configured to call on a UDF created in the customized application program and having a stored UDF identifier associated with said UDF.

19. A data processing device according to claim 18 further comprising a communication module for receiving the data from a database.

20. A data processing device according to claim 18 further comprising a graphical unit interface.

21. A data processing device according to claim 18 further comprising data entry and display means.
